(19) United States
(12) Patent Application Publication
(10) Pub. No.: US 2025/0065351 A1
(43) Pub. Date: Feb. 27, 2025

(54) PAINT SPRAYER WITH PRESSURIZED CONTAINER

(71) Applicant: Wagner Spray Tech Corporation, Plymouth, MN (US)

(72) Inventors: Shawn Cameron JOHNSON, Milaca, MN (US); Jeffrey Scott JERDEE, Brooklyn Park, MN (US); Douglas P. POZANC, Winona, MN (US)

(21) Appl. No.: 18/810,737

(22) Filed: Aug. 21, 2024

Related U.S. Application Data
(60) Provisional application No. 63/578,892, filed on Aug. 25, 2023.

(51) Int. Cl. B05B 9/08

(52) U.S. Cl. CPC B05B 9/0805

(57) ABSTRACT

A handheld liquid spraying system includes a liquid container assembly having a container. An air inlet is configured to receive air to pressurize the liquid container assembly. A collapsible liner is disposed within the container. A cap has a first portion extending into an opening of the container and a second portion having an outlet for a flow of the liquid from the container. A fastening mechanism is configured to engage the container and retain the cap with a portion of the collapsible liner secured between the cap and the container. A liquid sprayer assembly is removably couplable to the liquid container assembly and includes a stem adapter, a stem adapter nut having a set of threads configured to engage a set of threads on the cap, a spray orifice, and a control mechanism configured to control flow of the liquid through the spray orifice.

### CROSS-REFERENCE TO RELATED APPLICATION

The present application is based on and claims the benefit of U.S. provisional patent application Ser. No. 63/578,892, filed Aug. 25, 2023, the contents of which are hereby incorporated by reference in their entirety.

### BACKGROUND

A liquid spraying system can be used to spray a liquid from a liquid source to an application area. For example, paint can be sprayed by an applicator, such as a spray gun, to an application area, such as a surface of a wall. Some paint spraying systems include a container carried on a handheld assembly. The container is pressurized by air to provide a flow of paint therefrom.

The discussion above is merely provided for general background information and is not intended to be used as an aid in determining the scope of the claimed subject matter. The claimed subject matter is not limited to implementations that solve any or all disadvantages noted in the background.

### SUMMARY

A handheld liquid spraying system includes a liquid container assembly having a container. An air inlet is configured to receive air to pressurize the liquid container assembly. A collapsible liner is disposed within the container. A cap has a first portion extending into an opening of the container and a second portion having an outlet for a flow of the liquid from the container. A fastening mechanism is configured to engage the container and retain the cap with a portion of the collapsible liner secured between the cap and the container. A liquid sprayer assembly is removably couplable to the liquid container assembly and includes a stem adapter, a stem adapter nut having a set of threads configured to engage a set of threads on the cap, a spray orifice, and a control mechanism configured to control flow of the liquid through the spray orifice.

A handheld liquid spraying system includes a container assembly including a container having an air inlet configured to receive air to pressurize the liquid container assembly. A cap has a first portion extending into an opening of the container and a second portion having a liquid flow outlet. A collapsible liner is disposed within the container and has a first state in which the collapsible liner is expanded and holds a maximum volume. A second state in which the collapsible liner is collapsed by pressurization of the container by the air received through the air inlet, wherein a volume of residual liquid in the container, when the collapsible liner is in the second state, is less than or equal to five percent of the maximum volume. A sprayer assembly removably couplable to the liquid container assembly. The liquid sprayer assembly includes a spray orifice and a control mechanism configured to control flow of the liquid through the spray orifice assembly.

A container assembly for a spray apparatus includes a container having an air inlet configured to receive air to pressurize the container assembly, a cap having a first portion extending into an opening of the container and a second portion having a liquid flow outlet, a collapsible liner disposed within the container, and a fastening mechanism configured to engage the container and retain the cap with a portion of the collapsible liner secured between the cap and the container.

These and various other features and advantages will be apparent from a reading of the following Detailed Description. This Summary and Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a perspective view of a paint spraying system, in one example.

FIG. 2 is a cross-sectional view of a paint spraying system, in one example.

FIG. 3 is a partial exploded view of a paint spraying system, in one example.

FIG. 4 is a bottom perspective view of a paint container, in one example.

FIG. 5 is a top view of a paint container, in one example.

FIG. 6 is a side view of a paint container, in one example.

FIG. 7 is a cross-section view of a paint container, in one example.

FIG. 8 is a bottom perspective view of a cap, in one example.

FIG. 9 is a bottom plan view of a cap, in one example.

FIG. 10 is a bottom perspective view of a cap, in one example.

FIG. 11 is a cross-sectional view of a cap, in one example.

FIG. 12 is an enlarged view of a portion of a paint spraying system, in one example.

FIG. 13 is a cross-sectional view of a cap and a collapsible liner in an expanded state, in one example.

FIG. 14-1 is a cross-sectional view of the cap and the collapsible liner, shown in FIG. 13, in a collapsed state, in one example.

FIG. 14-2 is a cross-sectional view of the cap and the collapsible liner, shown in FIG. 13, in a collapsed state, in one example.

FIG. 15 is a bottom perspective view of a collar, in one example.

FIG. 16 is a cross-sectional view of a collar, in one example.

FIG. 17 is a top view of an adapter nut, in one example.

FIG. 18 is a cross-sectional view of an adapter nut, in one example.

FIG. 19 is an enlarged view of a portion of a paint spraying system, in one example.

While the above-identified figures set forth one or more examples of the disclosed subject matter, other examples are also contemplated, as noted in the disclosure. In all cases, this disclosure presents the disclosed subject matter by way of representation and not limitation. It should be understood that numerous other modifications and examples can be devised by those skilled in the art which fall within the scope and spirit of the principles of this disclosure.

### DETAILED DESCRIPTION OF THE DRAWINGS

There are many different types of fluid spraying systems that spray a liquid, such as paint, onto a surface using a spray gun or other spraying device. The liquid is often supplied from a container or other liquid reservoir.

As used herein, examples of paint include substances composed of coloring matter or pigment suspended in a liquid medium as well as substances that are free of coloring matter or pigment. Paint can also include preparatory coatings. Paint can be applied to coat a surface as a liquid or a gaseous suspension, for example, and the coating provided can be opaque, transparent, or semi-transparent. Some particular examples include, but are not limited to, latex paint, oil-based paint, stain, lacquers, varnish, inks, and the like.

Further, while examples are described herein in the context of applying paint, other types of fluid can be applied to surfaces, including, but not limited to, primer, lacquers, foams, textured materials, plural components, adhesive components, etc.

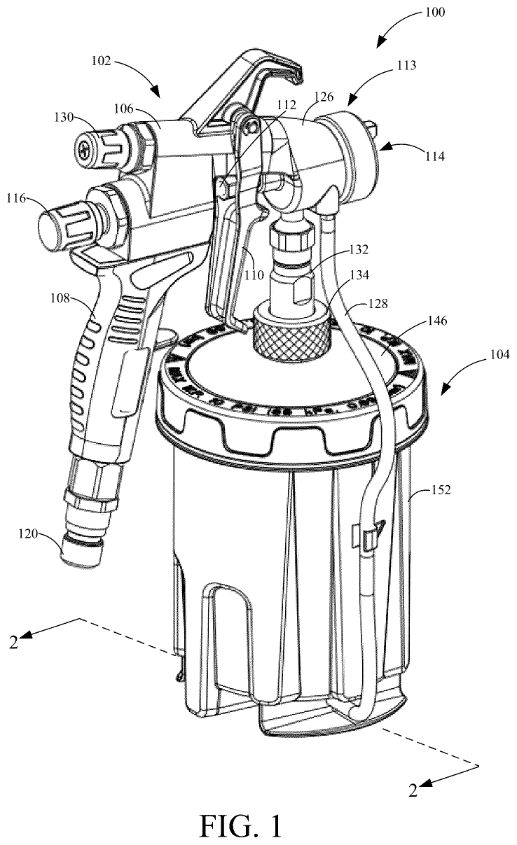

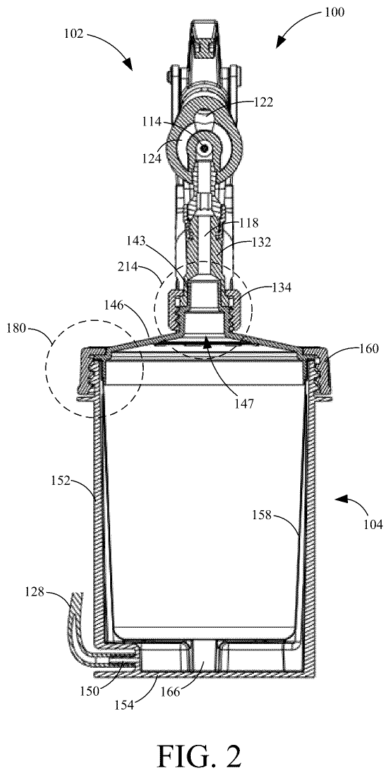

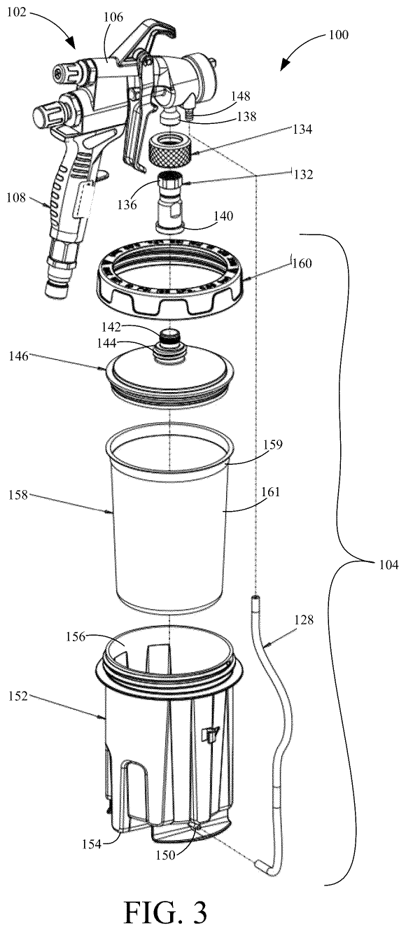

FIG. 1 is a perspective view of a paint spraying system 100, in one example. System 100 includes a paint sprayer assembly 102 and a paint container assembly 104 removable couplable to paint sprayer assembly 102. FIG. 2 is a cross-sectional view of system 100 taken along line 2-2, and FIG. 3 is an exploded view of system 100. FIGS. 2 and 3 will be discussed below in conjunction with FIG. 1.

Paint sprayer assembly 102 is illustratively in the form of a hand-held spray gun having a spray gun body 106. A handle portion 108 is configured to be grasped by the user's hand and a control mechanism (illustratively a trigger 110) configured to control a flow of paint. Trigger 110 is pivotably connected to spray gun body 106 and is actuatable by the user's fingers to move a valve 112 (e.g., a needle valve) to control a flow of paint through a spray tip assembly 113 having a spray orifice 114. A control mechanism 116 (illustratively a knob) is actuatable (e.g., rotatable) to adjust a set point of valve 112, thereby controlling an amount of paint released from spray orifice 114 upon actuation of trigger 110. Retraction of valve 112 from a valve seat (not shown in FIGS. 1, 2, and 3) allows paint to flow from paint container assembly 104 through a paint flow path 118 to spray orifice 114.

An air source inlet 120 is located on an end of handle portion 108 and configured to receive air from an air source, such as an air turbine through a hose connected to air source inlet 120. Air source inlet 120 can include any suitable connector for coupling the hose to paint spraying system 100.

An air flow path 122 is formed from air source inlet 120 to an air chamber 124 formed in a front-end portion 126 of spray gun body 106. A portion of the pressurized air in air chamber 124 exits spray tip assembly 113, such as through spray orifice 114 and/or air orifices proximate spray orifice 114.

A portion of the pressurized air in air chamber 124 flows through an air tube 128 into paint container assembly 104 to pressurize paint container assembly 104 and aid in paint flow through paint flow path 118.

An air flow control mechanism 130 (illustratively a knob) is actuatable (e.g., rotatable) to control an air flow control valve (not shown in FIGS. 1, 2, and 3), to control the air flow rate from spray tip assembly 113.

Paint sprayer assembly 102 includes a stem adapter 132, through which a portion of paint flow path 118 is formed, and an adapter nut 134. A first end 136 of stem adapter 132 is coupled to a corresponding connector 138 on spray gun body 106, such as by corresponding threads. Adapter nut 134 engages and seals against a second end 140 of stem adapter 132. The second end 140 receives, therein, a tip or protrusion 142 having one or more sealing flanges that engage and seal with an inner surface of stem adapter 132 proximate second end 140. This engagement prevents fluid from leaking through the interface 143 of stem adapter 132 and paint container assembly 104. Adapter nut 134 engages a connection mechanism 144 to secure paint container assembly 104 to stem adapter 132. Stem adapter 132 and adapter nut 134 can be formed of material such as, but not limited to, metals and metal alloys. Tip 142 and connection mechanism 144 are formed on a portion of a cap 146.

Air tube 128 couples to, and provides air flow between, corresponding connectors 148 (on paint sprayer assembly 102) and 150 (on paint container assembly 104). Connector 150 is illustratively formed on a side portion of a container 152 proximate the bottom surface 154 of container 152. Container 152 includes an interior compartment 156 sized to receive a collapsible liner 158.

In one example, collapsible liner 158 is formed of a polymeric material, such as, but not limited to, polypropylene, polyethylene, or the like, that allows deformation under pressure from the air flow through air tube 128. The collapsing of liner 158 forces paint contained within liner 158 through tip 142 and into stem adapter 132.

In one example, an upper portion 159 of liner 158 has a thickness of less than or equal to 0.2 inches. In one example, upper portion 159 has a thickness of less than or equal to 0.18 inches. In one example, upper portion 159 has a thickness of less than or equal to 0.15 inches.

In one example, a lower portion 161 of liner 158 has a thickness of less than or equal to 0.15 inches. In one example, lower portion 161 has a thickness of less than or equal to 0.12 inches. In one example, lower portion 161 has a thickness of less than or equal to 0.09. In one example, lower portion 161 has a thickness of less than or equal to 0.07

Liner 158 is retained between cap 146 and container 152, and cap 146 is secured to container 152 by a collar 160. Cap 146 includes an outlet 147 for a flow of the paint as liner 158 is collapsed by the air pressure.

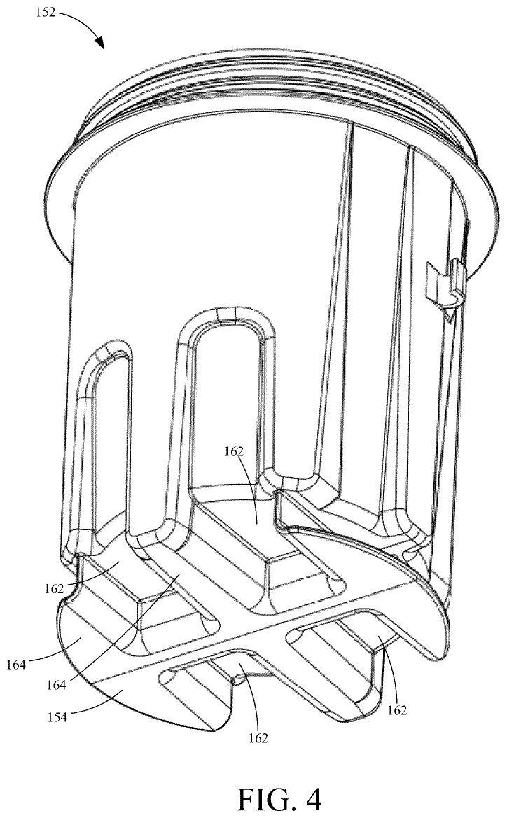

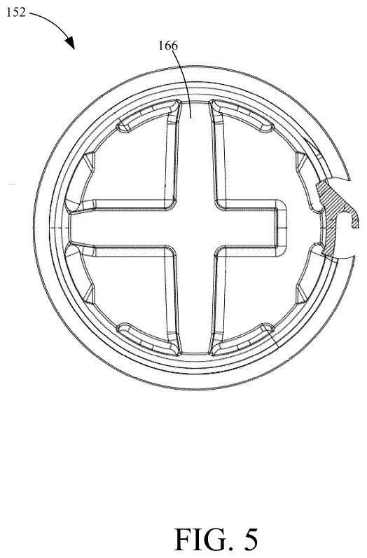

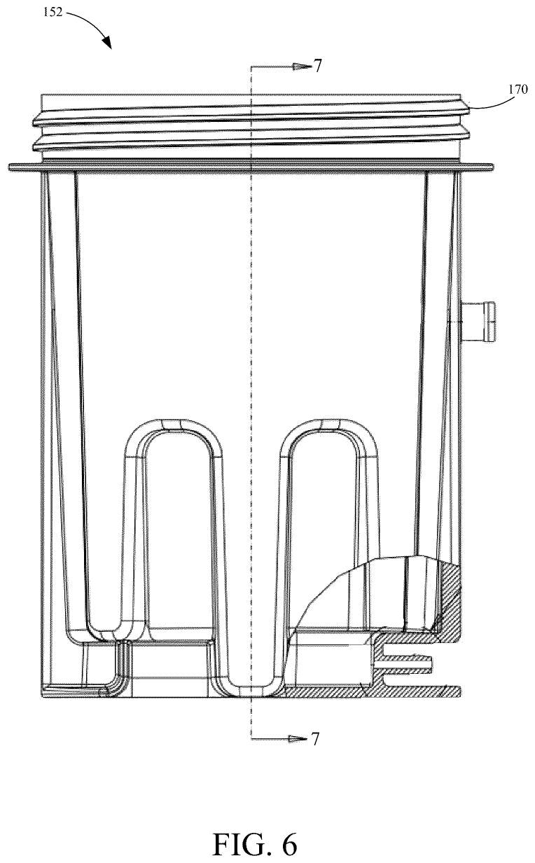

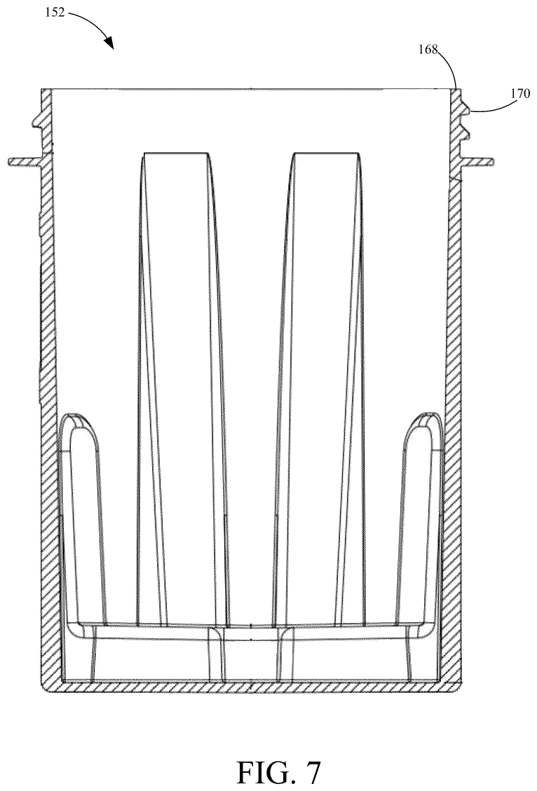

FIGS. 4-7 illustrate one example of container 152. FIG. 4 is a bottom perspective view, FIG. 5 is a top view, FIG. 6 is a side view, and FIG. 7 is a cross-section view taken at line 7-7 in FIG. 6.

As shown in FIG. 4, the bottom surface 154 of container 152 includes a plurality of raised portions 162, that are raised relative to a lower plane defined by lower surfaces 164. As shown in FIG. 2, liner 158 engages and is supported by raised portions 162 and the lower surfaces 164 form air channels 166 that allow air flow from connector 150 along a portion of the bottom surface of liner 158. The pressurized air in air channels 166 acts to force the liner 158 in an upward direction to cause paint to flow through paint flow path 118.

As shown in FIGS. 6 and 7, container 152 includes an upper rim surface 168 and one or more fastening mechanisms 170, illustratively a set of threads. Container 152 can be formed of any suitable material capable of withstanding desired operating pressures within container 152. Examples of materials include, but are not limited to, polymeric material, such as polypropylene, polyethylene, polycarbonates, or the like.

In one example, paint container assembly 104 is configured to withstand ten pounds per square inch (PSI). In another example, paint container assembly 104 is configured to withstand pressures greater than ten PSI. In another example, paint container assembly 104 is configured to withstand pressures greater than twenty PSI.

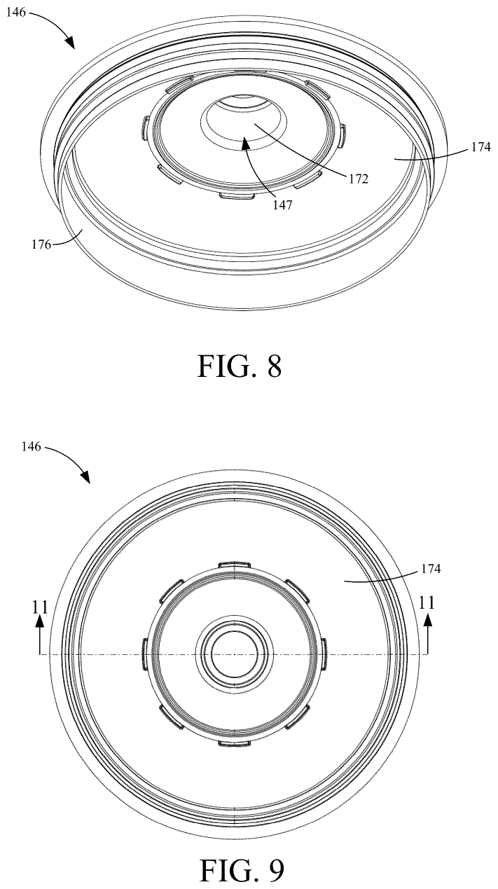

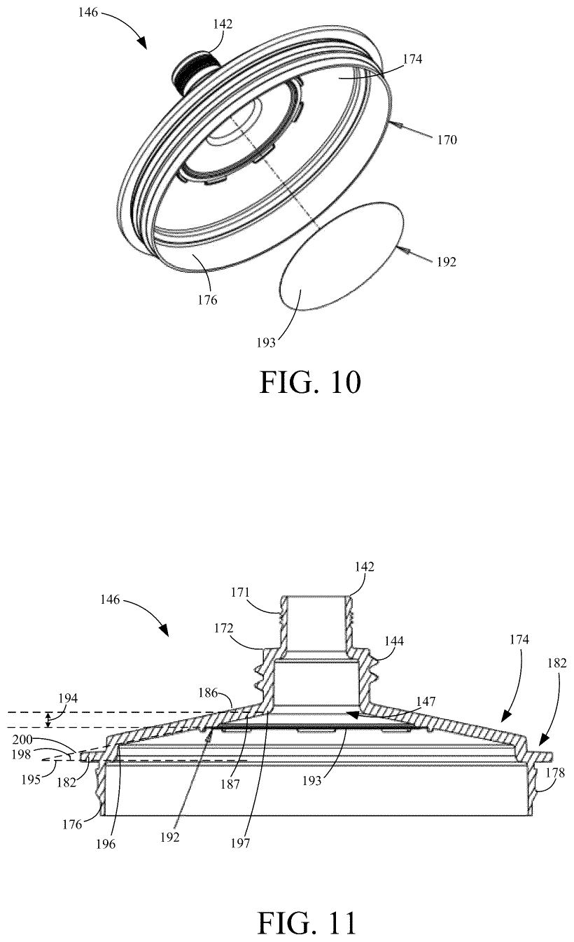

FIGS. 9-11 illustrate one example of cap 146. FIG. 8 is a bottom perspective view, FIG. 9 is a bottom plan view, FIG. 10 is a bottom perspective view, and FIG. 11 is a cross-sectional view taken at line 11-11 shown in FIG. 9. Line 11-11 passes through a center of outlet 147.

As noted above, cap 146 includes a tip 142 having an outer surface with one or more sealing features, such as ribs 171. The sealing features engage with stem adapter 132, as discussed above. Connection mechanism 144 includes a set of attachment features, such as one or more threads, that engage adapter nut 134. Connection mechanism 144 is formed on a cylindrical portion 172.

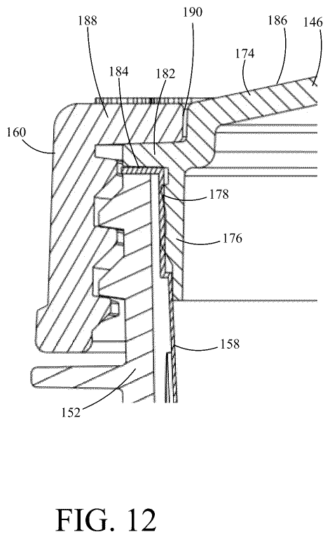

Upper portion 174 extends from cylindrical portion 172 to a lower portion 176 having an outer surface with sealing mechanisms (such as one or more ribs) 178 that are configured to engage an interior or liner 158, as shown in FIG. 12, which is an enlarged view of a portion identified in FIG. 1 by dashed circle 180. A radially extending portion 182 extends outwardly from upper portion 174 and is configured to engage a top lip portion 184 of liner 158. Accordingly, cap 146, container 152, and liner 158 form a sealing engagement to prevent paint from leaking out of liner 158.

Upper portion 174 of cap 146 forms an upper surface 186, which generally faces a direction of paint sprayer assembly 102, and a lower surface 187 that generally faces container 152. A rim 188 of collar 160 has a rim opening 190 formed therein. Upper portion 174 of cap 146 extends through rim opening 190, and rim 188 extends over and contacts only a portion of upper surface 186 (e.g., portion 182). In one example, collar 160 contacts less than twenty five percent of upper surface 186. In one example, collar 160 contacts less than fifteen percent of upper surface 186. In one example, collar 160 contacts less than five percent of upper surface 186.

In one example, cap 146 is formed of a polymeric material (such as, but not limited to, polypropylene, polyethylene, etc.) having characteristics that lend cap 146 to being a disposable or single use part, while having sufficient tensile and flexural strength to support pressurization of container assembly 104. (e.g., cap 146 is configured to withstand tensile and/or flexural forces generated by pressures up to ten PSI). In one example, upper portion 174 and/or lower portion 176 have a thickness of less than or equal to 0.3 inches. In one example, upper portion 174 and/or lower portion 176 have a thickness of less than or equal to 0.2 inches. In one example, upper portion 174 and/or lower portion 176 have a thickness of less than or equal to 0.1 inches.

As shown in FIGS. 10 and 11, cap 146 includes a filter device 192 that is retained proximate outlet 147 formed by cylindrical portion 172. Filter device 192 operates to filter debris, contaminants, etc. from the paint before the paint flows through paint flow path 118.

Filter device 192 illustratively includes a disc filter having a substantially planar shape and a thickness of about 0.014 inches. In one example, filter device 192 comprises a mesh screen formed of polypropylene. Further, filter device 192 can be secured to cap 146 using any suitable fastener or attachment. In one example, filter device 192 is secured to cap 146 by ultrasonic welding. Alternatively, or in addition, filter device 192 can be snap-fit to cap 146.

Filter device 192 has a top surface facing outlet 147 and a lower or bottom surface 193 facing in an opposite direction, i.e., away from outlet 147 and toward the bottom of container 152. Filter device 192 has a diameter that is less than the inner diameter of portion 182, and is positioned relatively close to outlet 147 (e.g., filter device 192 is located closer to outlet 147 than a plane 195 defined across the interface of upper portion 174 and lower portion 176). In one example, lower surface 193 is a distance 194 from outlet 147 that is less than 0.2 inches. In one example, distance 194 is less than 0.15 inches. In one example, distance 194 is less than 0.13 inches. A reduced distance between filter device 192 and outlet 147 encourages a reduction in residual media, discussed in further detail below. However, as the cross-sectional area of filter device 192 decreases, a back pressure for a given flow rate through filter device 192 can increase, which can adversely affect the flow through outlet 147. In one example, the bottom surface of filter device 192 is positioned less than 0.5 inches from outlet 147. In one example, the bottom surface of filter device 192 is positioned less than 0.25 inches from outlet 147. In one example, the bottom surface of filter device 192 is positioned approximately 0.211 inches from outlet 147.

FIG. 11 illustrates a line 200 that corresponds, at least to some extent, to a shape of upper portion 174, at the cross-section of line 11-11. Line 200 extends from a first point 196 to a second point 197. First point 196 is positioned along upper portion 174 proximate an interface of upper portion 174 and lower portion 176. Second point 196 is positioned along upper portion 174 proximate an edge of outlet 147.

In the illustrated example, upper portion 174 has a conical shape and line 200 follows (e.g., is parallel to) upper surface 186 and/or lower surface 187 between points 196 and 197. In other examples, upper portion 174 can have other shapes. For example, upper surface 186 and/or lower surface 187 can have a shape that is, for example, concave, convex, etc. In this way, line 200 can pass through points 196 and 197, but not follow surfaces 186 and/or 187.

An angle 198 is formed between upper portion 174 of cap 146 and plane 195 defined across the interface of upper portion 174 and lower portion 176. Plane 195 is substantially parallel to the top end of container 152 and outlet 147.

In one example, angle 198 is relatively small, thus reducing the space between plane 195 and lower surface 187 of upper portion 174. A reduced angle 198 reduces the space between the top of the liner and cap 146, which facilitates the bottom surface of liner 158, when liner 158 is collapsed, to be closer in distance to upper portion 174 of cap 146. This, in turn, reduces the amount of paint that remains in paint container assembly 104 when the liner is entirely collapsed. In other words, the configuration of angle 198 reduces the amount of paint that cannot be expelled through flow path 118 (referred to herein as a residual volume). This unused paint results in waste and excess cleaning procedures after use.

In one example, angle 198 is less than or equal to twenty-two degrees. In one example, angle 198 is less than or equal to twenty degrees. In one example, angle 198 is less than or equal to fifteen degrees. In one example, angle 198 is less than or equal to ten degrees.

If angle 198 is too small, however, upper portion 174 can become structural weak and unable to withstand pressurization of container 152, resulting in deformation and/or failure of cap 146. In one example, angle 198 is greater than five degrees. In one example, angle 198 is greater than ten degrees.

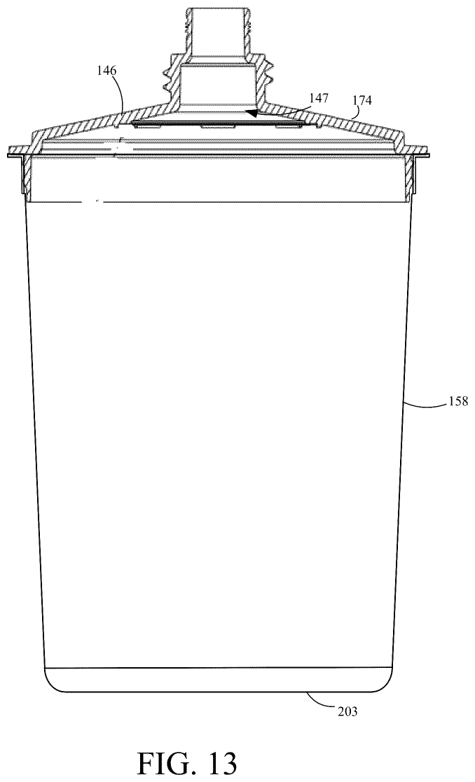

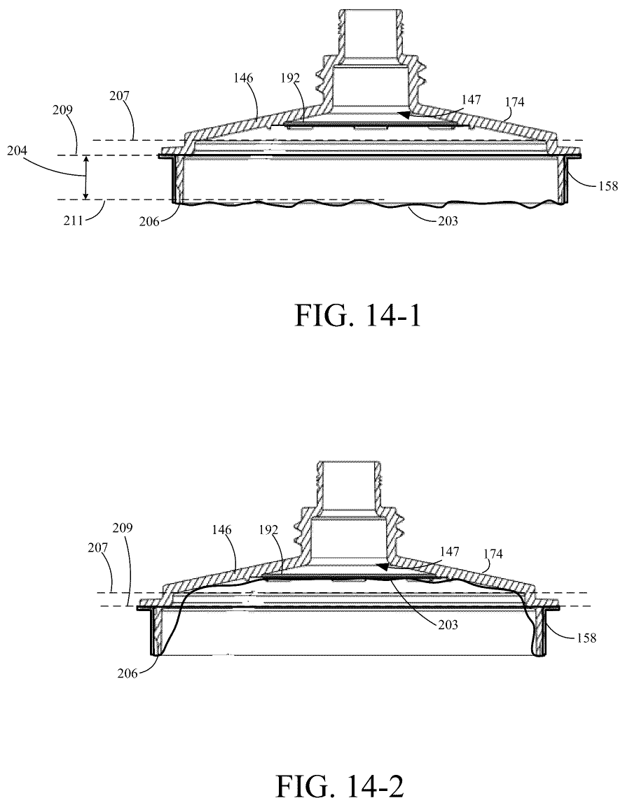

FIGS. 13 and 14-1 are cross-sectional views of cap 146 and liner 158. FIG. 13 shows liner 158 in a fully expanded state and FIG. 14 shows liner 158 in a fully collapsed state. In the fully expanded state of FIG. 13, liner 158 is configured to hold a maximum volume of paint to be sprayed. In some examples, the maximum volume is two hundred milliliters (ml), five hundred ml, one thousand ml, to name a few.

During operation, liner 158 is collapsed by air pressurization (e.g., less than fifty PSI, twenty PSI, ten PSI, etc.) of container 152, thereby causing paint to be forced through outlet 147 until liner 158 reaches the fully collapsed state of FIG. 14-1, upon which no further paint can be forced through outlet 147 by the air pressurization. In the fully collapsed state, at least a portion of a bottom end 203 of liner 158 is within a threshold distance 204 of a top end of liner 158. In one example, liner 158 is configured to collapse until bottom end 203 is in contact with, or otherwise proximate, a bottom edge 206 of cap 146. In one example, threshold distance 204 between a plane 209 defined across a top end of liner 158 a plane 211 (generally aligned with bottom end 203 is less than 0.5 inches. In one example, at pressures up to ten PSI, liner 158 is configured to collapse such that at least a portion of the bottom end 203 of liner 158 is above a plane 207 defined across the lower end of the conical portion of cap 146. In one example, at pressures up to ten PSI, liner 158 is configured to collapse such that at least a portion of the bottom end 203 is proximate (e.g., within 0.5 inches) of filter 192. In one example, as shown in FIG. 14-2, in the fully collapsed state, the bottom end 203 of liner 158 resides between plane 207 and filter 192. In one example, bottom end 203 is configured to contact the bottom surface of filter 192.

In the fully collapsed state of FIG. 14-1, the residual volume of paint (also referred to as residual media) resides between bottom end 203 of liner 158 and outlet 147. In one example, the residual volume is less than fifteen percent of the maximum volume in the fully expanded state. In one example, the residual volume is less than ten percent of the maximum volume in the fully expanded state. In one example, the residual volume is less than five percent of the maximum volume in the fully expanded state. In one example, the residual volume is less than two percent of the maximum volume in the fully expanded state.

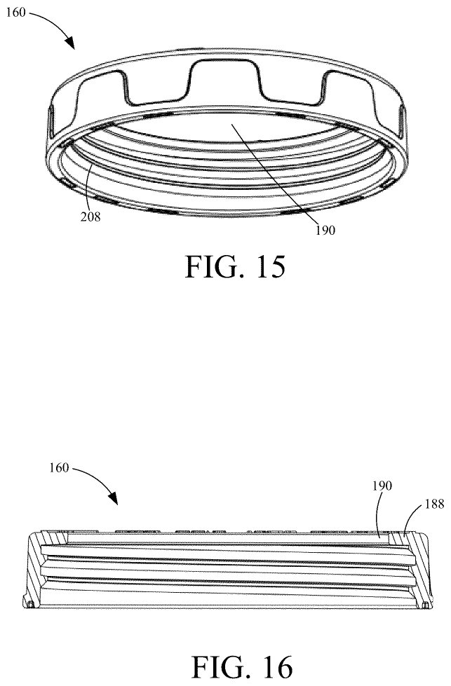

FIGS. 15 and 16 illustrate one example of collar 160. FIG. 15 is a bottom perspective view and FIG. 16 is a cross-sectional view. As noted above, collar 160 includes opening 190 through which a portion of cap 146 extends. Collar 160 includes a plurality of fastening mechanisms (illustratively one or more threads) 208 configured to engage corresponding mechanisms on container 152, as discussed above. Collar 160 can be formed, in one example, of a nylon material with glass fiber reinforcement (e.g., nylon 66 GF30, etc.).

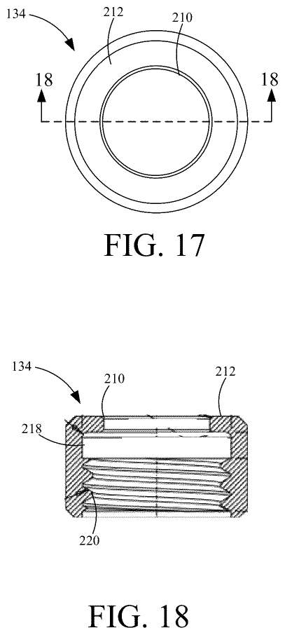

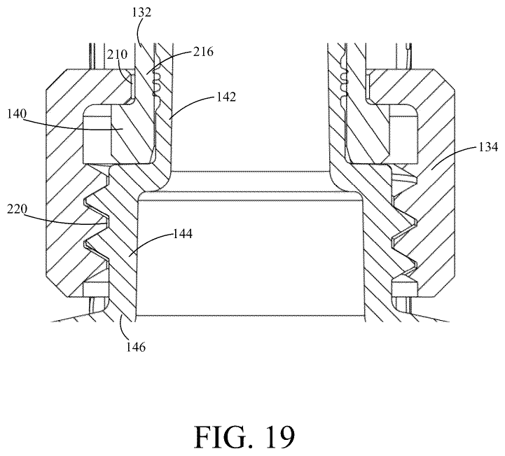

FIGS. 17 and 18 illustrate one example of adapter nut 134. FIG. 17 is a top view and FIG. 18 is a cross-sectional view taken at line 18-18 in FIG. 17. As illustrated, adapter nut 134 includes an opening 210 formed in a top surface 212. Opening 210 is sized to accommodate stem adapter 132, as illustrated in FIG. 19 which is an enlarged view of a portion identified in FIG. 2 by dashed circle 214. Opening 210 engages a first portion 216. A second portion 218 of adapter nut 134 has an enlarged inner diameter configured to accommodate and engage the second end 140 of stem adapter 132 and retain stem adapter 132 against tip 142 when threads 220 are engaged to cap 146.

It should also be noted that the different examples described herein can be combined in different ways. That is, parts of one or more examples can be combined with parts of one or more other examples. All of this is contemplated herein.

As used herein, if a description includes “one or more of” or “at least one of” followed by a list of example features with a conjunction “or” between the penultimate example feature and the last example feature, then this is to be read such that (1) one exemplary embodiment includes at least one of or one or more of each feature of the listed features, (2) another exemplary embodiment includes at least one of or one or more of only one feature of the listed features, and (3) another exemplary embodiment includes some combination of the listed features that is less than all of the features and more than one of the features.

As used herein, if a description includes “one or more of” or “at least one of” followed by a list of example features with a conjunction “and” between the penultimate example feature and the last example feature, then this is to be read such that the exemplary embodiment includes at least one of or one or more of each feature of all the listed features.

As used herein, if a description includes “one or more of” or “at least one of” followed by a list of example features with a conjunction “and/or” between the penultimate example feature and the least example feature, then this is to be read such that, in one example, the description includes “one or more of” or “at least one of” followed by a list of example features with a conjunction “or” between the penultimate example feature and the last example feature, and, in another example, the description includes “one or more of” or “at least one of” followed by a list of example features with a conjunction “and” between the penultimate example feature and the last example feature.

It should also be noted that the different examples described herein can be combined in different ways. That is, parts of one or more examples can be combined with parts of one or more other examples. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts mentioned above are disclosed as example forms of implementing the claims.

What is claimed is:

1. A handheld liquid spraying system comprising:
a liquid container assembly comprising:
a container having an air inlet configured to receive air to pressurize the liquid container assembly;
a collapsible liner disposed within the container and configured to hold a liquid, wherein the collapsible liner is configured to collapse in response to pressurization of the container; and
a cap having a first portion extending into an opening of the container and a second portion having an outlet for a flow of the liquid from the container;
a fastening mechanism configured to engage the container and retain the cap with a portion of the collapsible liner secured between the cap and the container; and
a liquid sprayer assembly removably couplable to the liquid container assembly, the liquid sprayer assembly comprising:
a stem adapter configured to receive the flow of the liquid from the outlet of the cap;
a stem adapter nut having a set of threads configured to engage a set of threads on the cap, wherein a portion of stem adapter is secured between the stem adapter nut and the outlet of the cap;
a spray orifice; and
a control mechanism configured to control flow of the liquid through the spray orifice.

2. The handheld liquid spraying system of claim 1, wherein the liquid comprises a paint.

3. The handheld liquid spraying system of claim 1, wherein
the fastening mechanism comprises a collar having a rim forming a rim opening therein,
the second portion of the cap extends through the rim opening, and
the rim extends over and contacts less than twenty five percent of an upper surface of the cap.

4. The handheld liquid spraying system of claim 3, wherein the cap comprises a polymeric material having a rigidity configured to withstand ten pounds per square inch (PSI).

5. The handheld liquid spraying system of claim 1, wherein an angle between the second portion of the cap and a plane defined along an intersection of the first portion and the second portion is less than twenty two degrees.

6. The handheld liquid spraying system of claim 5, wherein the angle is less than fifteen degrees.

7. The handheld liquid spraying system of claim 1, wherein
the container comprises a first end having the opening and a second end opposite the first end, and
the liquid container assembly comprises a filter device configured to filter the flow of the liquid, the filter device having a top surface facing the outlet of the cap and a bottom surface facing the second end of the container, the bottom surface of the filter device being disposed at a distance from the outlet that is less than 0.15 inches.

8. The handheld liquid spraying system of claim 7, wherein the filter device comprises a disc filter that is substantially planar.

9. The handheld liquid spraying system of claim 1, wherein the liquid sprayer assembly comprises a handle having an air source inlet configured to receive pressured air from an air hose.

10. A handheld liquid spraying system comprising:
a container assembly comprising:
a container having an air inlet configured to receive air to pressurize the container assembly;
a cap having a first portion extending into an opening of the container and a second portion having a liquid flow outlet;
a collapsible liner disposed within the container, the collapsible liner having
a first state in which the collapsible liner is expanded and configured to hold a maximum volume of the collapsible liner, and
a second state in which the collapsible liner is collapsed by pressurization of the container by the air received through the air inlet, wherein a volume of residual liquid in the container, when the collapsible liner is in the second state, is less than or equal to five percent of the maximum volume of the collapsible liner; and
a sprayer assembly removably couplable to the container assembly, the sprayer assembly comprising:
a spray orifice; and
a control mechanism configured to control flow of liquid through the spray orifice.

11. The handheld liquid spraying system of claim 10, wherein the pressurization of the container is less than fifty pounds per square inch (PSI).

12. The handheld liquid spraying system of claim 11, wherein the maximum volume is greater than or equal to four hundred milliliters (ml), and the volume of the residual liquid is less than or equal to five ml.

13. The handheld liquid spraying system of claim 10, wherein
the collapsible liner has a first end that is secured relative to the cap and a second end that is opposite the first end, and
when the collapsible liner is in the second state, the second end is located proximate the cap.

14. The handheld liquid spraying system of claim 10, wherein
the container comprises a first end having the opening and a second end opposite the first end, and
the container assembly comprises a filter device configured to filter the flow of the liquid, the filter device having a top surface facing the liquid flow outlet of the cap and a bottom surface facing the second end of the container, the bottom surface of the filter device being disposed at a distance from the liquid flow outlet that is less than 0.15 inches.

15. The handheld liquid spraying system of claim 14, wherein the filter device comprises a disc filter.

16. The handheld liquid spraying system of claim 14, wherein the filter device is substantially planar.

17. The handheld liquid spraying system of claim 10, wherein an angle between the second portion of the cap and a plane defined along an intersection of the first portion and the second portion is less than twenty two degrees.

18. The handheld liquid spraying system of claim 17, wherein the angle is less than fifteen degrees.

19. A container assembly for a spray apparatus, the container assembly comprising:
a container having an air inlet configured to receive air to pressurize the container assembly;
a cap having a first portion extending into an opening of the container and a second portion having a liquid flow outlet;
a collapsible liner disposed within the container; and
a fastening mechanism configured to engage the container and retain the cap with a portion of the collapsible liner secured between the cap and the container.

20. The container assembly of claim 19, wherein the collapsible liner has
a first state in which the collapsible liner is expanded and configured to hold a maximum volume of the collapsible liner, and
a second state in which the collapsible liner is collapsed by pressurization of the container, wherein a volume of residual liquid in the container, when the collapsible liner is in the second state, is less than or equal to five percent of the maximum volume of the collapsible liner.
